(19) United States
(12) Patent Application Publication
(10) Pub. No.: US 2009/0226662 A1
(43) Pub. Date: Sep. 10, 2009

(54) Surface Coverings Containing Reclaimed VCT Material, and Methods and Systems For Making and Using Them

(75) Inventors: Mary Katherine Dyczko-Riglin, Penns Grove, NJ (US); Dennis H. Bradway, Salem, NJ (US); John Emmons, West Grove, PA (US); Carl Wilmore, Alloway, NJ (US)

Correspondence Address: KILYK & BOWERSOX, P.L.L.C., 400 HOLIDAY COURT, SUITE 102, WARRENTON, VA, 20186, US

(73) Assignee: MANNINGTON MILLS, INC., Salem, NJ (US)

(21) Appl. No.: 12/398,540

(22) Filed: Mar. 5, 2009

Related U.S. Application Data
(60) Provisional application No. 61/034,185, filed on Mar. 6, 2008.

(51) Int. Cl. B32B 27/28; C09D 11/00; C08K 3/26; B32B 27/32; B29B 9/08; E04F 15/10; B29C 47/36

(52) U.S. Cl. 428/95; 524/543; 524/425; 428/220; 428/343; 264/118; 156/71; 425/113

(57) ABSTRACT

Surface coverings, such as vinyl flooring, carpeting and the like, comprising reclaimed VCT material, are disclosed. Vinyl composition tile (VCT) having at least 5% by weight reclaimed vinyl composition tile material which can include a surface adhesive, and filler, where the mixture is a thermoformed solidified material in individual tile form is disclosed. Methods for making these surface covering materials and using them to provide floor coverings are also disclosed. A system for presorting and grinding reclaimed VCT to provide feed material for these and other uses is also disclosed.

This patent application claims the benefit of U.S. Provisional Patent Application No. 61/034,185 filed Mar. 6, 2008, and is incorporated in its entirety by reference herein.

### BACKGROUND OF THE INVENTION

The present invention relates to surface coverings, such as flooring tile and carpets, containing reclaimed vinyl composition tile-containing material and processes for making and using these materials, and systems for sorting and grinding reclaimed vinyl composition tile-containing material for (re-)use in surface coverings.

Vinyl flooring has been a popular floor covering material for many years. Vinyl flooring has been available in either tile or sheet form for both commercial and residential use. Different categories of vinyl flooring are generally recognized. Solid and printed vinyl tiles in general contain a relatively high content of vinyl resin relative to any other co-ingredients. Vinyl composition tile (VCT) is another category of vinyl flooring, comprised primarily of filler, such as limestone and/or clay, in combination with vinyl resin.

As finished flooring material, VCT has been used extensively in commercial, institutional and public building applications, such as, for example, malls, schools, healthcare facilities, convention and exposition centers, civic buildings, private office buildings, sports facilities, and so forth. VCT flooring is durable, easy to maintain and more moisture-resistant than many alternative flooring materials. VCT is also a resilient type flooring surface, in that the material offers some rebound or resilience property upon compression. VCT is often composed of colored vinyl chips formed into generally planar solid sheets by heat and pressure, and cut into squares or other useful shapes. Tiles are available in a variety of colors from flooring manufacturers. Manufacturers have created vinyl tiles that very closely resemble wood, stone, terrazo, and concrete. VCT can be cut and assembled into colorful and decorative patterns. Tiles are applied to a smooth, leveled bare floor or sub-floor usually using an adhesive that remains tacky after installation of the tiles.

Although durable, vinyl composition tile has a useful life. After extended time periods of use, vinyl composition tile can ultimately degrade and need to be replaced. In the past, old or post-consumer vinyl composition tile was landfilled. A substantial amount of vinyl composition tile has been used to cover flooring surfaces in some large buildings. Therefore, a significant amount of scrap vinyl composition tile can be generated when old flooring is replaced. The landfilling of used vinyl composition tile can be subject to laws, regulations and/or ordinances. Some landfills may restrict or strictly control landfilling of VCT. Therefore, the disposal of such post-consumer vinyl composition tile can be problematic and/or costly.

### SUMMARY OF THE INVENTION

A feature of the present invention is to provide a surface covering, such as vinyl flooring or carpeting, and more particularly to provide vinyl composition tile (VCT), made with at least a portion of reclaimed vinyl composition tile material or almost exclusively or entirely made from reclaimed VCT material.

As an advantage of the present invention, it surprisingly has been discovered that post-consumer vinyl composition tile can be successfully recovered and reworked into new vinyl composition tile flooring manufacture essentially as is, inclusive of any surface adhesive associated with the recovered tile material, other than physically particulating the recovered material, without impairing processability or adversely impacting flooring tile product performance. The ability to reclaim and reuse post-consumer VCT in new VCT flooring manufacture is a significant technical development. This innovation can offset rising material costs and occasional unavailability of some vinyl resins and/or copolymers used in the VCT flooring surface covering industry. The ability to reuse large amounts of old or post-consumer VCT tile in accordance with embodiments of the present invention into new flooring production reduces virgin material requirements for manufacture. Further, embodiments of the present invention can make VCT material essentially a renewable resource as old VCT tile can be recovered from existing flooring and re-used in very high proportions relative to any virgin materials used for “new” VCT manufacture. Embodiments of the present invention also significantly reduce or eliminate waste disposal requirements otherwise associated with replacement of old VCT tile. As can be appreciated, embodiments of the present invention provide “greener” floor coverings from an environmental standpoint.

In another embodiment, a method of making this VCT flooring with reclaimed VCT material is provided.

In yet another embodiment, a method of using VCT flooring is provided.

In other embodiments, post-consumer vinyl composition tile can be successfully recovered and reworked into other new vinyl flooring (e.g., solid vinyl tile (SVT), sheet vinyl), polymeric-poured floors, or other resilient floor coverings.

As another advantage of the present invention, it surprisingly has been discovered that post-consumer vinyl composition tile can be successfully recovered and reworked into new carpeting manufacture, or manufacture of other surface coverings having a textile wear surface, essentially as is, inclusive of any surface adhesive associated with the recovered tile material, other than physically particulating the recovered material, without impairing processability or adversely impacting carpeting product performance.

In another embodiment, a system for sorting and grinding post-consumer reclaimed VCT material is provided, which prepares the material for use in surface covering production, such as vinyl flooring (e.g., VCT, solid vinyl tile, sheet vinyl), carpeting, and other applications. The sorting and grinding system can form part of a larger integrated system, which further includes a surface covering production line per se which uses the sorted/ground product of the sorting and grinding line as a product ingredient and component.

Additional features and advantages of the present invention will be set forth in part in the description that follows, and in part will be apparent from the description, or can be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates, in part, to a flooring composition material (e.g., a VCT material) comprising a mixture comprising virgin vinyl polymer, more than 5% by weight reclaimed vinyl composition tile (VCT) material, and a predominant amount of total filler (from all sources), wherein the mixture is a thermoformed solidified material in individual tile form. The reclaimed material, and rework containing the reclaimed material, is thermoplastic in overall property, and, therefore, can be thermoformed more than once, which is an attribute utilized in the present invention. The filler content of the finished flooring composition material can be sourced from reclaimed VCT, extraneously (supplemental) added virgin filler, recycled production (tile) scrap, or any combination of these.

The present invention also relates, in part, to a flooring composition material (e.g., a VCT material) comprising a mixture comprising no virgin polymer, and optionally no virgin filler, and/or optionally no virgin plasticizer, but contains more than 90% (e.g., 95% to 100% ) by weight reclaimed vinyl composition tile (VCT) material. The mixture is a thermoformed solidified material in individual tile form. The reclaimed material, and rework containing the reclaimed material, is thermoplastic in overall property, and, therefore, can be thermoformed more than once, which is an attribute utilized in the present invention. The mixture can contain recycled production (tile) scrap.

The flooring composition material is in individual or discrete tile form. In a particular embodiment, the solidified product is VCT. In another embodiment, the flooring composition material comprises a mixture comprising the virgin vinyl polymer and more than 5 wt %, particularly more than 20 wt %, and even more particularly up to 40 to 60 wt % or more of the reclaimed vinyl composition tile material (based on the total weight of the flooring composition). In one embodiment, the reclaimed VCT material is “as-lifted-off the-floor” condition post-consumer or otherwise used VCT flooring material. The reclaimed VCT material also can be used as an additive source to reduce virgin additive requirements of not only filler but also other additives in new VCT flooring production. In one embodiment, VCT rework comprising reclaimed VCT material, virgin material(s) and any recycled production tile scrap, contains a predominant amount of filler. The reclaimed VCT can be used as a filler source in new tile manufacture. The amount of filler carried into the rework from the reclaimed VCT alone can be sufficient to provide a newly finished VCT flooring product with a predominance of filler. Extraneous (supplemental) filler as virgin filler and/or recycled production tile scrap also can be used as filler sources in new tile production, which, together with any amounts of filler sourced from reclaimed VCT, provide a rework composition comprised predominantly of filler. In one further embodiment, the VCT flooring composition material containing the reclaimed VCT comprises a generally planar discrete tile material having a thickness, for instance, of from about ⅛ inch to ½ inch, and a parallelogram shape (e.g., square, rectangle, rhombus, etc.), triangular, or other geometrical shape. In one further embodiment, the VCT tile is a parallelogram shape having a side length of about 24 inches (61 cm) or less. In one further embodiment, the VCT tile is a parallelogram shape such as a square having about 8 to about 20 inch side dimensions, particularly about 10 to about 18 inch side dimensions, and more particularly about 12 to about 16 inch side dimensions, or alternatively the tile shape is a rectangular or strip shape having respective side dimensions of about 14 to 18 inches by about 22 to 24 inches. In one embodiment, the flooring composition material containing the reclaimed VCT can further comprise at least one additive selected from at least one plasticizer, and at least one stabilizer, or a combination thereof.

A method is provided for making flooring composition material, comprising the steps of recovering post-consumer solid vinyl composition tile material as reclaimed vinyl composition material. Then, the reclaimed VCT material is comminuted into small pieces. The comminution optionally comprises sorting and cold grinding processes for removal of undesired materials and sizing of the reclaimed VCT material. The pieces of reclaimed VCT material, and virgin vinyl polymer material, are heated and softened, and are combined before, during and/or after they are heated and softened, and optionally further combined with extraneous filler, to provide a thermoformable mixture thereof which contains more than 5% by weight reclaimed vinyl composition tile material. The VCT composition can contain a predominant amount of filler. The thermoformable material is thermoformed and shaped into and solidified into a form of a solid sheet material, which is then cut, die-punched, or otherwise subdivided into individual discrete tiles.

In making the flooring composition material, such as VCT material, the mixture of reclaimed vinyl composition tile material and optional virgin polymer material can optionally be compounded with at least one additive selected from at least one plasticizer, at least one stabilizer, or a combination thereof. The thermoforming technique can comprise, for instance, calendering, molding, and/or extrusion, and the cutting technique can comprise die-punching. The comminution of the reclaimed vinyl composition tile can comprise, for instance, grinding the recovered vinyl composition tile material to an average particle size of about ¼ inch to about 1.5 inch. The proportions of reclaimed vinyl composition tile material used in the mixture with virgin polymer material include the proportions indicated above. In other embodiments, vinyl flooring composition material can be made by providing a thermoformable mixture which contains 5% or less by weight reclaimed vinyl composition tile material.

A method is provided for covering a floor surface with VCT comprising the steps of removing solid vinyl composition tile material adhered to a floor surface to provide loose reclaimed vinyl composition tile material. Then, the reclaimed vinyl composition tile material is comminuted into small pieces. As indicated, the comminution optionally comprises a combination of sorting and cold grinding processing. The pieces of reclaimed vinyl composition tile material, alone or with virgin vinyl polymer material, are heated and softened, and are combined before, during and/or after they are heated and softened, and optionally further combined with extraneous filler, to provide a thermoformable mixture thereof which contains more than 5% by weight reclaimed vinyl composition tile material. The VCT can contain a predominant amount of filler. The reclaimed VCT material used in new VCT manufacture according to embodiments of the present invention can be sourced from flooring(s) having the same or different tile styles or patterns. The thermoformable material is thermoformed into and solidified into a form of a solid sheet, which is cut into individual discrete tiles. The individual tiles are adhered to an exposed surface to provide a floor surface covering. The floor surface from which the old or post-consumer VCT is reclaimed can be the same as or different than the floor surface receiving the tiles made with the reclaimed VCT material.

A system is provided for processing of reclaimed vinyl composition tile material, comprising a sorting and grinding line that receives and processes reclaimed VCT material for removal of undesired materials and sizing of the reclaimed VCT material. The sorting and grinding line can include, for example, a transfer device for transferring reclaimed VCT material to a vibratory bed for removing fine dust and sifting the material forward to pass over a magnetic separator to remove magnetically-attractable material, and onto a sorting conveyor. The sorting conveyor conveys the material such that it passes a metal detector used to detect metal for removal which had not been removed by the magnet. The sorting conveyor transports the material to a cold grinder or feeder thereof. The cold grinder breaks the material down into small pieces, such as chips. The sorted and ground material can be collected, such as in a collection bin. The collected sorted and ground material can be used in a variety of different applications, such as in vinyl flooring production (e.g., new VCT, solid vinyl tile (SVT), sheet vinyl), carpet production, other surface covering products, and other flooring products, such as luxury vinyl tiles, thermoplastic planks, or other uses. In a further embodiment, the sorting and grinding system includes a crusher which receives product of the cold grinder for crushing it into fine powder. The crushed fine powder can be used for inlaid tile production, or other applications. In another embodiment, the sorting and grinding system is integrated with a VCT production line. The VCT production line comprises a mixer combining the sorted ground product with fresh ingredients in a heat softened condition, a thernoformer for forming the resulting composition into a sheet, and a tile cutter for subdividing the sheet into individual tiles.

For purposes herein, the term “vinyl composition tile” or “VCT” refers to a category of vinyl flooring tile products that can be produced in compliance with ASTM F 1066 specification, in which the VCT is a vinyl resin-containing material that is comprised predominantly of filler. Vinyl composition tiles in substantial compliance with this standard or having other specifications may also be acceptable depending on the application. The term “solid vinyl tile” or “SVT” refers to a category of vinyl flooring tile products produced in compliance with ASTM F 1700 specification, in which the binder content consists of polymers and/or copolymers of vinyl chloride, other modifying resins and plasticizers that comprise 34% or more by weight of the finished tile. Further, and for purposes herein, SVT is not VCT. The term “vinyl flooring” generally encompasses resilient surface coverings having a vinyl content, such as VCT, SVT, sheet vinyl, and the like, unless indicated otherwise. The term “reclaimed” refers to polymer material that has been previously compounded at least once with one or more additives and thermoformed into a tile. “Recycled production scrap” and the like refers to tile scrap, trim, or waste and the like, collected during tile production and before the tile product is used in flooring. The term “rework” refers to “reclaimed material” that can be or has been combined with virgin or fresh ingredients, and any recycled production scrap, of an overall tile formulation. The reclaimed VCT can be re-used after recovery in a “raw” or “as-lifted-off-the-floor” condition without requirements for reconditioning the reclaimed VCT before reuse (e.g., without stripping off residual backing adhesive, purifying, etc.), although the post-consumer VCT can be and in one aspect preferably is physically modified by comminution techniques after recovery and prior to re-use. The term “virgin vinyl polymer” refers to polymer that is substantially pure polymer that has not been previously compounded with one or more additives and thermoformed into a tile. The term “thermoplastic” refers to polymeric-containing material that can be repeatedly resoftened by application of heat, reshaped while softened, and solidified into a hardened mass upon cooling. “Sorting” refers to a process wherein discrete objects are separated or classified based on at least one property, such as size, mass, material type (e.g., metallic or non-metallic), magnetic-attractability, and the like. “Particulating” refers to any process that physically breaks original tile pieces into a plurality of small pieces, and encompasses processes, such as grinding, pulverizing, milling, crushing, shredding, and/or comminuting, and the like. “Cold grinding” refers to particulating of original tile pieces at conditions below the softening temperature of the polymer content thereof.

It is to be understood that both the foregoing general description and the following detailed description are exemplary and explanatory only and are intended to provide a further explanation of the present invention, as claimed.

The accompanying drawings, which are incorporated in and constitute a part of this application, illustrate some of the embodiments of the present invention and together with the description, serve to explain the principles of the present invention.

### BRIEF DESCRIPTION OF DRAWINGS

FIG. 1 is a flow diagram of a process for making vinyl tile material made with reclaimed vinyl composition tile material according to various embodiments of the present invention.

FIG. 2 is a flow diagram of a sorting and grinding process for reclaimed VCT material, according to various embodiments of the present invention.

FIG. 3 is a side view of a sorting and grinding process line, according to various embodiments of the present invention.

FIG. 4 is an enlarged side view of a vibratory bed screen used in a sorting and grinding process line, according to various embodiments of the present invention.

FIG. 5 is a top perspective view of vibratory bed screen used in a sorting and grinding process, according to various embodiments of the present invention.

FIG. 6 is an enlarged plan view of a portion of a finger deck section of the vibratory bed screen of FIG. 5, according to various embodiments of the present invention.

FIG. 7 is a cross-sectional view of the finger deck section of FIG. 6 as taken along direction 7-7.

FIG. 8 is a flow diagram of a sorting and grinding process line used at the “comminute” stage shown in FIG. 1, according to other various embodiments of the present invention.

### DETAILED DESCRIPTION OF THE PRESENT INVENTION

The present invention relates to unique surface coverings, such as vinyl flooring and carpeting, and more particularly to unique vinyl composition tile (VCT) or other surface or floor coverings, made with reclaimed vinyl composition tile material. It also relates to the manufacture and installation of these modified surface covering materials as floor coverings.

VCT flooring products usually are generally made from combinations of vinyl resin and various additives that give these products their desired particular properties. Some of the additives commonly used in VCT flooring include: plasticizers, i.e., oily liquids that are used for example to soften the vinyl and provide flexibility to the formulation; stabilizers, used for example to minimize degradation and discoloration from heat and light; pigments, which are added during the manufacturing process to give vinyl a desired range of colors; and fillers, such as limestone or clay, and the like.

Once the additives have been combined with the resin, the resulting material is called vinyl compound, and often is provided in chip form. The nature of the vinyl compound allows versatility in the production process, enabling manufacturers to meet many of the performance requirements of various flooring applications. In the next stage of manufacturing, vinyl tile flooring is created.

VCT flooring in accordance with the present invention is generally manufactured by one of several methods, including: by melt-compounding the ingredients at high temperatures, then molding the hot material into the desired shape; or by using the calendering technique, in which the components are mixed together and then fed through a series of rollers that gradually squeeze the material to the desired gauge. The calendered sheet optionally can then be coated to increase abrasion and stain resistance. Although the total process and product raw materials can vary depending on the type of tile being produced, vinyl composition tile (VCT), for purposes of the present invention, generally contains a predominant amount of filler.

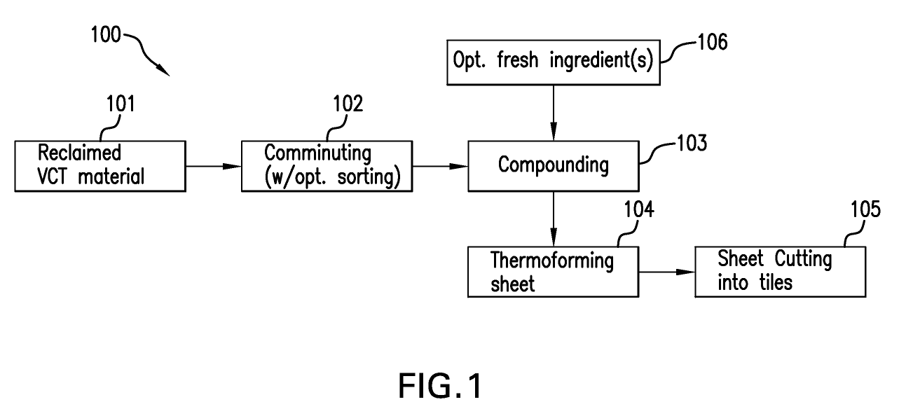

An exemplary process flow for making VCT flooring is shown in FIG. 1. As shown in FIG. 1, the process flow 100 can comprise comminuting 102 reclaimed VCT material 101 (which optionally includes sorting), compounding 103 (which optionally includes addition of one or more fresh (or virgin) ingredients 106), thermoforming of sheet material 104, and cutting of the solidified sheet material into individual tiles 105. Additional illustrative details and information on these various operations are provided herein where applicable.

Various types of VCT compositions containing virgin sources of vinyl chloride polymers and copolymers have been used that are compatible with flooring industry applications. VCT flooring compositions can include compositions, for example, containing vinyl chloride-vinyl acetate copolymer and/or compositions containing vinyl chloride-vinyl acetate and vinyl chloride homopolymer. The upper limit on the amount of vinyl chloride homopolymer that can be contained in a composition of a homopolymer of vinyl chloride and a copolymer of vinyl chloride-vinyl acetate can be 90-95% by weight or less of the combined amount of vinyl chloride homopolymer and a vinyl chloride-vinyl acetate copolymer, specifically 40-45% by weight as an example.

An advantage of the present invention is that it solves, at least in part, price and supply sensitivities of vinyl starting materials used in VCT manufacture in particular. Post-consumer VCT, formulated in low vinyl resin, high filler/additive content compositions, surprisingly has been found to be useful as a rework material in technically and economically meaningful proportions in new VCT production. It has been further determined that the recovered or reclaimed VCT does not need to be specially processed before re-use, such as to remove tackifying adhesives used when installing the old tile, and presently adhered to a surface, ordinarily the back surface, of the old tile. The surface adhesives present on the old VCT tile can comprise thermoplastic adhesives. These surface adhesives may comprise, for example, acrylic latexes, vinyl adhesives, and/or other types of adhesives such as asphalts, and so forth.

In this respect, the present invention relates, in part, to a flooring composition material, such as VCT material, comprising a mixture comprising virgin vinyl polymer, more than 5% by weight reclaimed vinyl composition tile material and, optionally, virgin filler, wherein the mixture is in a thermoformed solidified tile form. The VCT product of the present invention can contain a predominant amount of filler. The flooring composition also may optionally contain recycled production scrap. The reclaimed material, and rework material containing the reclaimed material, is a thermoplastic in overall properties, and, therefore, can be thermoformed more than once, which is an attribute utilized in the present invention. The filler content of the finished flooring composition material can be sourced from the reclaimed VCT, extraneously (supplemental) added filler, recycled production scrap, or from any combination of these.

The VCT products can comprise three major ingredients: filler, binder, and additives (e.g., pigment). Any one or more of these ingredients can be sourced from reclaimed VCT and/or fresh or virgin ingredients and/or recycled production scrap, provided that the reclaimed VCT constitutes more than 5 wt % of the overall composition. Filler is the predominant ingredient. It is to be understood that the reclaimed VCT contains filler and other materials, and the filler in the reclaimed VCT can be solely used or used in combination with virgin filler (if added) to make up the filler as the predominant ingredient. The binder system can be a combination of resin, with a small amount of plasticizer (like an oil) to improve flexibility. The resin utilized can be a combination of polyvinylchloride and polyvinyl acetate. The entire binder system can be less than 15% by weight of the total product because of the binding efficiency. The remaining components can be additives that provide color to the tile and longer term aging protection (against heat and light) for the product.

The flooring composition material, such as VCT material, can comprise a mixture comprising the virgin vinyl polymer and more than 5 wt %, particularly more than 20 wt %, and even more particularly 40 to 60 wt % or more of reclaimed vinyl composition tile material (based on the total weight of the material). Exemplary amounts include from 5.1 wt % to 100 wt % or more, from 5.5 wt % to 95 wt %, from 6 wt % to 90 wt %, from 10 wt % to 80 wt %, from 15 wt % to 75 wt %, from 20 wt % to 70 wt %, from 25 wt % to 65 wt %, from 30 wt % to 60 wt %, from 35 wt % to 55 wt %, and any ranges or amounts within these ranges. VCT rework can contain reclaimed VCT material, any optional virgin material(s) and any optional recycled production scrap. The VCT rework contains a predominant amount of filler. For purposes of the present invention, the predominant amount of filler means the highest wt % component or 50 wt % or more of filler from any source whether virgin and/or recycled, based on the weight of the VCT material, and can be from 51 wt % to 98 wt %, or 60 wt % to 95 wt %, or 70 wt % to 90 wt %, or 75 wt % to 89 wt % of filler. Reclaimed VCT can be used as a filler source in a proportion in new tile manufacture that provides a newly finished VCT flooring product containing a predominant amount (≧50 wt %) of filler, apart from any amounts of added extraneous (supplemental) amounts of virgin filler and/or any filler from recycled production scrap. Extraneous virgin filler and/or recycled production scrap optionally can be added to supplement any filler carried into the new flooring mixes via reclaimed VCT, sufficient to provide a predominant amount of filler. The flooring composition material containing the reclaimed VCT can comprise a generally planar material having a thickness of from about ⅛ inch to ½ inch. The VCT tile can have a parallelogram shape (e.g., square, rectangle, rhombus, etc.), triangular, or other geometrical shape. The VCT tile can be a parallelogram shape having a side length of about 24 inches (61 cm) or less. The VCT tile can be a parallelogram shape, such as a square, having from about 8 to about 20 inch side dimensions, particularly from about 10 to about 18 inch side dimensions, and more particularly from about 12 to about 16 inch side dimensions, for example, square shapes of about 12 inches by about 12 inches, or about 16 inches by about 16 inches, and so forth. Alternatively, the VCT tile can have a rectangular or strip shape having respective side dimensions of from about 14 to 18 inches by about 22 to 24 inches, for example, a rectangular strip shape of about 16 inches by about 24 inches. The VCT flooring composition material containing the reclaimed VCT can further comprise at least one additive selected from at least one plasticizer, and at least one stabilizer, or a combination thereof. Any combination of these various features can be present in the reclaimed VCT.

As an option, a flooring composition material, such as VCT material, can contain a mixture comprising no virgin vinyl polymer, but contains 80 wt % to 100 wt % or from 90 wt % to 100 wt % (such as 95 wt % to 100 wt %) reclaimed vinyl composition tile material and, optionally, no virgin filler, and/or optionally no virgin plasticizer, and/or optionally no virgin material at all. As an option, the mixture (or the flooring composition material) can contain less than 10 wt %, or less than 5 wt %, or less than 3 wt %, or less than 1 wt % (e.g., from 0.01 wt % to 5 wt %) (based on the weight of the flooring composition material) virgin material. So, as an option, the flooring composition can contain very little virgin material and can be exclusively or almost exclusively reclaimed VCT material. The mixture can be in a thermoformed solidified tile form. The VCT product of the present invention can contain a predominant amount of filler. The flooring composition also may optionally contain recycled production scrap. The reclaimed material, and rework material containing the reclaimed material, is a thermoplastic in overall properties, and, therefore, can be thermoformed more than once, which is an attribute utilized in the present invention. The filler content of the finished flooring composition material can be sourced from the reclaimed VCT, optionally extraneously (supplemental) added filler, and/or optional recycled production scrap, or from any combination of these. When this is done, the method of preparing the material is the same as described herein, but the mixers may be adjusted to accommodate for mixing and melting since such a reclaimed mixture can be a heavier or denser or more viscous mixture.

In one aspect, the present invention relates to a VCT flooring composition comprising at least 5 wt % by weight reclaimed vinyl composition tile material. The VCT floor composition contains a predominant amount of filler (e.g., a wt % that is the higher than any other component or an amount over 50 wt % of the overall composition weight). The mixture is in a thermoformed solidified tile. The reclaimed or rework material is a thermoplastic in overall properties, and, therefore, can be thermoformed more than once, which is an attribute utilized in the present invention. The filler content of the finished VCT flooring composition material can be sourced from the reclaimed VCT, extraneously (supplemental) added filler, recycled production scrap, or any combination of these. The amount of filler can be from 50 wt % to 98 wt %, from 51 wt % to 98 wt %, from 55 wt % to 95 wt %, from 60 wt % to 90 wt %, from 65 wt % to 85 wt %, from 70 wt % to 80 wt %, from 75 wt % to 80 wt %, and any amount within one of these ranges, based on the wt % of the overall composition. The amount of reclaimed vinyl composition tile material can be any of the amounts provided earlier above.

The VCT flooring composition material is in individual tile form. In a particular embodiment, the solidified product is VCT. The reclaimed VCT material used in new tile manufacture according to embodiments of the present invention can be sourced from flooring(s) having the same or different tile styles or patterns.

Virgin vinyl polymer can be used in formulating the VCT flooring composition material containing the reclaimed VCT, and the virgin polymer can comprise a vinyl chloride homopolymer and a vinyl copolymer, such as a vinyl chloride-vinyl acetate copolymer, wherein the vinyl chloride homopolymer can be present in the composition in an amount from 1 wt % to greater than 50% by weight of the combined amount of vinyl chloride homopolymer and a vinyl copolymer, such as vinyl chloride-vinyl acetate copolymer (e.g., 1 wt % to 20 wt %, 20 wt % to 40 wt %, 40 wt % to 60 wt %, 60 wt % or greater, 65 wt % or greater, 70 wt % or greater; 75 wt % to 99 wt %). As a non-limiting example, the amount of vinyl chloride homopolymer in the virgin polymer can be 80% to 99 wt % by weight of the combined amount of vinyl chloride homopolymer and vinyl chloride-vinyl acetate copolymer, or may be 70% -99% (or more) by weight of the combined amount of vinyl chloride homopolymer and vinyl chloride-vinyl acetate copolymer or may be 80% -90% by weight of the combined amount of vinyl chloride homopolymer and vinyl chloride-vinyl acetate copolymer. The copolymer and homopolymer can have any K-value or molecular weight. More than one type of homopolymer and/or vinyl polymer (e.g., copolymer) can be present in the composition. The virgin polymer can be used in formulating the VCT flooring composition material containing the reclaimed VCT and can contain less than 1% by weight or 0% by weight of vinyl copolymer, based on the combined amount of the vinyl chloride homopolymer and vinyl copolymer and/or other copolymer. Essentially, in this embodiment of the present invention, a VCT flooring composition can be obtained without any virgin copolymer or substantially no virgin copolymer present.

The vinyl chloride homopolymer of the present invention (if present) may have any K-value, as determined according to test method DIN 53726, of 58 or less, such as from about 57 to about 51. The vinyl chloride homopolymer may have an inherent viscosity, as determined according to test method ASTM D1243 of from about 0.49 to about 0.60. The vinyl chloride homopolymer may have a relative viscosity of from about 1.50 to about 1.90.

As a non-limiting example, a particular homopolymer that has been found to be useful in the present invention is a vinyl chloride homopolymer resin provided by Georgia Gulf Corporation and designated by the product code “1050.” The 1050 homopolymer is a low molecular weight vinyl suspension resin having the following characteristics as set forth in Table I:

TABLE I

| ASTM Cell Classification: | | ASTM D1755 | GP1-16140 |
|---|---|---|---|
| Inherent Viscosity: | | ASTM D1243 | 0.49 +/− 0.02 |
| Relative Viscosity: | | | 1.55 |
| K-value | | DIN53726 | 49 |
| Bulk density | lbs/ft³: | ASTM D1895 | 33.0 min |
| | Gms/cm³: | | 0.528 min |

| Percent Volatiles: | | GGC 02-05-00 | 0.35 max |
|---|---|---|---|
| Syntron Contamination, | | GGC 02-22-00 | 100 max |
| Particles/100 gms | | | |
| Residual Vinyl Chloride | | ASTM D3749 | 10.0 max |
| Monomer, ppm | | | |
| Hunterlab Color, | “L” | GGC 02-25-00 | 94.0 typical |
| | “a” | | 0.60 typical |
| | “b” | | 3.00 typical |

| | |
|---|---|
| Particle Size Distribution: | ASTM D1921 |

| | | |
|---|---|---|
| Percent retained on | 40 mesh: | 0 max |
| | 60 mesh: | 5 max |
| | 200 mesh: | 39 max |

| | |
|---|---|
| Pan | 7 max |

While Table I provides properties for one specific homopolymer, it is to be understood that any vinyl chloride homopolymer resin can be used, such as a vinyl chloride homopolymer, having one or more of these properties or having one or more of these properties within 40% or within 20% or within 10% of the property values set forth in Table I can be used. The present invention is not limited to this particular virgin homopolymer.

The virgin vinyl copolymer also can be, at least in part, any copolymer conventionally used to form vinyl composition tiles. The vinyl chloride-vinyl acetate copolymer may be any conventional vinyl chloride-vinyl acetate copolymer that can be used in vinyl resins and in vinyl composition tiles. A typical vinyl chloride-vinyl acetate copolymer may contain 12 to 14 wt. % vinyl acetate, although other amounts are possible. As a non-limiting example, a particular copolymer that has been found to be useful in the present invention is a vinyl chloride-vinyl acetate copolymer suspension resin provided by Petco (Petroquimica Colombiana E.A.) and designated by the product code “CR-80A.” The CR-80A copolymer has the following characteristics as set forth in Table II:

TABLE II

| | Test Method | CR-80A |
|---|---|---|
| Appearance | | White Powder |
| K-value | DIN 53726 | 50 ± 1 |
| Inherent Viscosity | ASTM D 1243 | 0.51-0.56 |
| Relative Viscosity | 1% by weight in | 1.58-1.66 |
| | Cyclohexanone @ 25° C. | |
| Bulk Density, g/l | ASTM D 1895, Method A | 600 min. |
| Particle Size | | |
| % passes through sieve 40 | ASTM D 1921 | 100% min. |
| % passes through sieve 200 | | 30% max. |
| Volatile Content, % | ASTM D 3030 | 2 max. |
| Bound acetate content, % | P-COP-01-08 | 13 ± 1 |
| Residual VCM content, | ASTM D 3749 | 150, Typ. |
| ppm | | |

With respect to the properties set forth in Table II for the preferred copolymer, it is to be understood that any vinyl polymer (e.g., copolymer, terpolymer) can be used in the present invention. Preferably, the polymer has one or more of the properties set forth in Table II or has properties within 40% or within 20% or within 10% of any one or more of the property values set forth in Table II.

The reclaimed VCT, and any virgin vinyl chloride homopolymer and any virgin vinyl copolymer (e.g., vinyl chloride-vinyl acetate copolymer) can be combined or mixed in any order and by any method known in the art for mixing or combining vinyl resins. For example, the virgin vinyl chloride homopolymer and the vinyl chloride-vinyl acetate copolymer can be mixed to form a preblend before or after combination with ground reclaimed VCT. Both the vinyl chloride homopolymer and the vinyl copolymer (e.g., vinyl chloride-vinyl acetate copolymer) can be in solid form, such as in the form of particles such as powders or pellets, that can be blended and combined by any suitable means, such as an extruder, mixer, and the like.

In another aspect, the present invention relates to a vinyl composition tile formulation that includes at least 5% by weight reclaimed VCT, a vinyl chloride homopolymer, a vinyl copolymer (e.g., vinyl chloride-vinyl acetate copolymer), at least one plasticizer, at least one filler, and optionally, at least one stabilizer, wherein the vinyl chloride homopolymer is present in the formulation in an amount from 1 wt % to greater than 50% by weight of the combined amount of vinyl chloride homopolymer and a vinyl copolymer, such as a vinyl chloride-vinyl acetate copolymer (e.g., 1 wt % to 20 wt %, 20 wt % to 40 wt %, 40 wt % to 60 wt %, 60 wt % or greater, 65 wt % or greater, 70 wt % or greater; 75 wt % to 99 wt %). The amount of vinyl chloride homopolymer in the vinyl composition tile formulation can be 80% to 99% by weight of the combined amount of vinyl chloride homopolymer and vinyl copolymer (e.g., vinyl chloride-vinyl acetate copolymer), or may be 70% -99% (or more) by weight of the combined amount of vinyl chloride homopolymer and vinyl copolymer (e.g., vinyl chloride-vinyl acetate copolymer) or may be 80% -90% by weight of the combined amount of vinyl chloride homopolymer and vinyl copolymer (e.g., vinyl chloride-vinyl acetate copolymer). The vinyl chloride homopolymer has a molecular weight polymer that is lower than conventional vinyl chloride homopolymers, as described above. The vinyl composition tile formulation may also include other ingredients that are typically added to vinyl tile compositions, such as pigments or processing aids. The amounts of the reclaimed VCT can be any one of the amounts stated earlier in this application.

The vinyl tile composition according to the present invention can contain from about 5 wt % to about 100 wt % reclaimed VCT. About 8 wt % to about 13 wt % of the composition can comprise vinyl chloride homopolymer and/or vinyl copolymer (e.g., vinyl chloride-vinyl acetate copolymer) as described above as virgin material, from the reclaimed VCT, or a combination thereof, from about 80 wt % to about 90 wt % of filler (comprised of filler content of the reclaimed VCT and/or any supplemental filler added to the masterbatch), from about 0.2 wt % to about 0.8 wt % of the stabilizer as virgin material, from the reclaimed VCT, or a combination thereof, from about 3 wt % to about 6 wt % of the plasticizer as virgin material, from the reclaimed VCT, or a combination thereof, and from about 0.2 wt % to about 2.0 wt % of other ingredients as virgin material, from the reclaimed VCT, or a combination thereof, such as pigments or processing aids, or other ingredients mentioned herein based on the weight of the composition.

The filler, as supplied via the reclaimed VCT and/or as freshly added, may be any filler, including any conventional inorganic filler, which can be used in vinyl composition tile. Examples include, but are not limited to, hydrated alumina, magnesium carbonate, calcium sulfate, carbon black, fly ash, cement dust, wood flour, cellulose-derived materials, ground rice hulls, clay, talc, calcium carbonate, barium sulfate, silicates, aluminum trihydrate, and the like. The filler can be recycled from any source. An inorganic filler typically provides dimensional stability and reduced elasticity to a vinyl composition tile, and may provide properties of fire resistance. As a non-limiting example, limestone (e.g., calcium carbonate with magnesium carbonate) may be used as the filler. A specific non-limiting example is dolomitic limestone (which can be screened), such as supplied by Specialty Minerals, Inc. under the product code DF-5025 and having a top mesh size of about 50 and a percent passing a 200 mesh sieve of about 25 wt %. Other inorganic fillers that can be used include clay, talc, silicates, or aluminates. Freshly added or supplemental filler may be in any physical form that allows it to be mixed or blended with the other ingredients to form a vinyl composition tile formulation that can be processed into a vinyl composition tile. Typically, added filler is in the form of particles.

A stabilizer typically provides heat stability and/or UV light stability to a vinyl composition tile formulation. The stabilizer can be introduced via the reclaimed VCT, but virgin stabilizer can be added to the vinyl composition tile formulation containing reclaimed VCT and/or optional virgin polymer. For example, a stabilizer may be used to minimize degradation and/or discoloration caused by exposure to heat and light, including conditions encountered in the manufacture of a vinyl composition tile. The stabilizer according to the present invention is preferably selected for effectiveness with the particular homopolymer-copolymer blend of the present invention and may be a calcium-zinc stabilizer. The zinc content of a calcium-zinc stabilizer may be greater that what is acceptable for a conventional homopolymer-copolymer blend. In particular, a calcium-zinc stabilizer containing 5.8 wt % or more zinc may be used, such as 6.0 wt % to about 10.0 wt % zinc. Specific non-limiting examples of zinc-calcium stabilizers are supplied by Chemson, Inc. under the product codes of PTP113 (5.8% zinc, 10.5% calcium by weight). Other examples of stabilizers include, but are not limited to, barium-cadmium stabilizers, barium-zinc stabilizers, organotin stabilizers, epoxidized soybean oils, and the like.

The plasticizer may be any plasticizer, including any conventional plasticizer, that can be used in vinyl resins. Although the plasticizer can be introduced via the reclaimed VCT, it is an option to add virgin plasticizer to the vinyl tile formulation containing reclaimed VCT. Examples include, but are not limited to, processing oils, polyesters, polyethers, polyether esters, and/or mixtures thereof. The plasticizer can be in the form of an oily liquid that softens vinyl and adds flexibility to a composition containing a vinyl resin. For example, the plasticizer may be a phthalic diester or a mixture of phthalic diesters, such as a mixture of diisononyl phthalate (DINP) and butyl benzyl phthalate. A suitable plasticizer containing 10 wt % diisononyl phthalate and 90 wt % butyl benzyl phthalate, for example, is provided by Ferro Corp. designated with a product code of Santicizer-160 (S-160). Other examples of plasticizers include, but are not limited to, di(2-ethylhexyl) phthalate (DOP), diisooctyl phthalate (DIOP), ditridecyl phthalate (DTDP), dihexyl phthalate (DHP) and diiosdectyl phthalate (DIDP), and the like. The preferred selection criteria of plasticizers are to enhance flexibility, resiliency, and/or melt flow.

As an option, one or more coupling agents can be present in the vinyl composition tile formulation, such as a maleic anhydride. The coupling agent(s) is especially preferred when 1% or less by weight of vinyl copolymer is present. Generally, the coupling agent can be present in an amount sufficient to permit sufficient coupling of the homopolymer and/or other components. Amounts can be, for instance, from about 5% by weight or less (e.g., 4% to 0.1 wt %) based on the weight of the homopolymer and vinyl copolymer present. Other amounts can be used.

The vinyl composition tile formulation may be in any physical form suitable for storage and/or for use to form a vinyl composition tile. For example, all of the ingredients except the plasticizer are typically solid ingredients and are typically in particulate or pellet form. Accordingly, these ingredients can be mixed in any order and by any method known in the art for combining particulate solids, and the plasticizer, which is typically a liquid, may be blended into the resulting mixture. The vinyl composition tile formulation may be premixed and stored for a period of time prior to use, or may be mixed just before, or even during, a process for manufacturing vinyl composition tile.

The vinyl composition tile formulation can optionally contain one or more colorants, modifying resins, cross-linking agents, antioxidants, foaming agents, tackifiers, and/or other conventional organic or inorganic additives commonly used in vinyl or in surface coverings, such as, but not limited to, UV-stabilizers, antistatic agents, thermal stabilizers, flame retardants, all used in amounts known to those skilled in the art. The components, additional layers and/or methods of U.S. Pat. Nos. 5,112,671; 4,614,680; 4,187,131; 4,172,169, 4,423,178; 4,313,866; and 5,380,794 can be used in the present application and these patents are incorporated in their entirety be reference herein.

For purposes of the present invention, the vinyl composition tile of the present invention generally contains the components present in the vinyl composition tile formulations described herein.

In another aspect, the present invention relates to a vinyl composition tile that is made from a vinyl composition tile formulation as described above. In particular, the present invention in this aspect relates to a vinyl composition tile comprising reclaimed VCT, virgin vinyl chloride homopolymer, virgin vinyl copolymer (e.g., vinyl chloride-vinyl acetate copolymer), at least one freshly added plasticizer, at least one freshly added stabilizer, and optionally at least one supplemental added filler, wherein the vinyl chloride homopolymer is present in the formulation in an amount of from 1 wt % to 50 wt %, or greater than 50% by weight of the combined amount of vinyl chloride homopolymer and a vinyl copolymer (e.g., vinyl chloride-vinyl acetate copolymer). The vinyl chloride homopolymer and vinyl copolymer (e.g., vinyl chloride-vinyl acetate copolymer), and the relative amounts thereof, plasticizer, stabilizer, and filler are all as described above.

The flooring composition material of the present invention can be used as a component in a surface covering or a layer thereof or a portion thereof. The surface covering can be a floor covering. The floor covering can be a vinyl containing floor covering or a non-vinyl containing floor covering. The floor covering can be a VCT, LVT, in-laid floor, vinyl sheet or roll, thermoplastic floor plank, cellulose-based or wood-based floor plank, carpet, carpet tile, and the like. The reclaimed vinyl composition tile material or the flooring composition material containing the same can be present in one or more components or layers of the floor covering product. Examples already have been provided above with respect to VCT and other similar products.

The reclaimed vinyl composition tile material and/or the flooring composition material containing the same can be a component used in one or more carpet layers, such as the pre-coat layer, a backing layer, a secondary backing layer, any other polymer layer in a carpet structure (such as an intermediate layer, strengthening layer, polymer layer, and the like). The backing can be a cushion-back or a hard back backing. In more detail, the backing can be a solid thermoplastic backing or a foamed thermoplastic backing. The thermoplastic foamed backing can be a foamed vinyl backing, such as a polyvinyl chloride foamed backing, such as a closed-cell vinyl foamed backing. Generally, the backings will contain a sufficient amount of at least one blowing agent and plasticizer and can include other ingredients conventionally used in backings. Chemically expanded thermoplastic foamed backings can be used as the secondary backing and can be prepared by casting a thermoplastic resin plastisol containing a blowing agent onto the back of the primary backing and heating to expand and fuse the plastisol. Alternatively, a pre-blown foamed secondary backing can be laminated, such as by heat, to the primary backing. The solid thermoplastic secondary backing can be similarly prepared by casting or by lamination. Conventional blowing agents can be used and include, but are not limited to azodicarbonamite, oxybissulfonyl hydroxide, substituted thiatriazole, and the like such as the ones described in U.S. Pat. No. 3,661,691 incorporated in its entirety by reference herein.

The reclaimed vinyl composition tile material and/or the flooring composition material containing the same can be present as a component where there are other vinyl containing components present or where there are no other vinyl containing components present in a layer. A vinyl containing and/or a non-vinyl containing polymer can be formulated or mixed or otherwise combined with the reclaimed vinyl composition, such as PVC, polypropylene, polyethylene, thermoplastic polyolefins (TPO's), thermoplastic elastomers (TPE's), styrene block polymers, bitumen, polymer modified bitumen, polyurethane, or any combination thereof. The thermoplastic material can be an aliphatic thermoplastic resin such as one derived by polymerization or copolymerization of an ethylenically unsaturated monomer. The monomer can be an ethylenically unsaturated hydrocarbon such as an olefin or a nitrile (such as an acrylonitrile), vinyl or vinylidene chloride, vinyl acetate, or an acrylate, such as ethylacrylate or methylmethacrylate. The thermoplastic material can be a polyethylene, ethylene/vinyl acetate, polyvinyl chloride, polyisobutylene, and the like. The thermoplastic material can be a vinyl-type material, such as a vinyl resin, and, more particularly, a polyvinyl chloride-type material. Suitable polymers can be derived from at least one monomer selected from acrylic, vinyl, chlorinated vinyl, styrene, butadiene, ethylene, butene, or copolymers or blends thereof. A layer can be or include a polymer or copolymer of a vinyl compound, e.g., polyvinyl chloride, polyvinylidine chloride, polyethylene chloride, polyvinyl acetate, polyvinyl acetal, and the like, and copolymers and mixtures thereof.

The reclaimed vinyl composition tile material and/or the flooring composition material containing the same can be present in one or more layers of a vinyl or non-vinyl carpet tile, a vinyl or non-vinyl broadloom carpet (e.g., HP), or a polyethylene containing carpet or other polyalkylene or olefin containing carpet. The reclaimed vinyl composition tile material and/or the flooring composition material containing the same can be used in latex containing carpets.

The reclaimed vinyl composition tile material and/or the flooring composition material containing the same can be used as a filler component in substitution or in addition to conventional fillers used in surface coverings, or the reclaimed vinyl composition tile material and/or the flooring composition material containing the same can be used as a filler and polymer additive, wherein the vinyl component (or polymer components present) in the reclaimed vinyl composition tile material and/or the flooring composition material containing the same serve as a recycled polymer addition that is melted and/or fused and/or otherwise thermoformed or otherwise pressed into a sheet or layer or otherwise present for use as a component in a layer(s) of a surface covering. The reclaimed vinyl composition tile material and/or the flooring composition material containing the same could be used in any amount in a layer of a surface covering such as from 0.01 wt % of the layer to 100 wt % of the layer, such as from about 0.1 wt % to 90 wt %, 0.5 wt % to 80 wt %, 1 wt % to 70 wt %, 5 wt % to 50 wt %, 5 wt % to 25 wt %, 1 wt % to 15 wt %, 2 wt % to 10 wt %, and amounts between, above, or below any of these amounts.

The reclaimed vinyl composition tile material and/or the flooring composition material containing the same can be incorporated as a component into a layer(s) of a surface covering by extruding alone or extruding with other components (e.g., virgin and/or other recycled material, like carpet or parts thereof, polymer, filler, plasticizers, fire retardants, and/or colorants, and the like) to form a layer. Fusing techniques using, for instance, a double belt press and heat, or other mixing/melting/coating techniques can be used instead with the reclaimed vinyl composition alone or with the other component(s).

As an option, the filler and the polymer part of the reclaimed vinyl composition tile material and/or the flooring composition material containing the same can be separated from each other, or at least the polymer amount can be reduced by various separation techniques, like gravity separation, heating or melting the polymer off from the filler, and so. This option can be useful where a more filler attribute alone in a surface covering is desired or where the polymer component in the reclaimed vinyl composition tile material and/or the flooring composition material containing the same is not compatible or less compatible with other components present.

A surface covering can include any surface covering which makes use of a backing and/or intermediate layer, such as a floor covering, wall covering, ceiling covering, countertop covering, and the like. Examples of floor coverings include, but are not limited to, textile substrates, such as carpets, and resilient flooring, such as vinyl or non-vinyl flooring or vinyl or non-vinyl surface coverings. Particularly preferred examples of textile substrates are hard backed and cushion backed textile substrates. The textile substrate can be a broadloom carpet, modular tile, or a wide roll carpet (e.g. 6 ft. wide). The textile substrate can comprise textile fibers defining a fibrous face, a primary backing to which the textile fibers are secured, and a secondary backing secured to the primary backing. The term “textile substrate” relates to, but is not limited to, a fiber, web, yarn, thread, sliver, woven fabric, knitted fabric, non-woven fabric, upholstery fabric, tufted carpet, fused fibers, or piled carpet formed from natural and/or synthetic fibers. The backing or backing layer can be or include any layer or substrate which has one or more additional layers adhered to a surface of the backing layer. Thus, the backing can be the layer which is in contact with the sub-surface, such as a sub-floor, or can be an intermediate layer with other layers above and below the intermediate backing layer. Besides optional virgin thermoplastic material, other conventional ingredients can be present along with the recycled or reclaimed material to form any carpet layer, such as a backing or intermediate layer, such as inorganic fillers, resins, plasticizers, stabilizers, foaming agents, and/or blowing agents, and the like. The amount of any one of these ingredients can be the same as conventionally used by those skilled in the art in forming such layers. Since a foaming or blowing agent can be incorporated into the reclaimed material, a foam layer or cushion-backed layer can be formed with the reclaimed material of the present invention.

The reclaimed VCT preferably is ground or otherwise comminuted into small particles before using it as rework in formulating a vinyl tile composition in embodiments of the present invention. The reclaimed VCT can be ground into particulate having an average particle size of from about 5 mm to about 50 mm (e.g., from 7 mm to 45 mm, 10 mm to 40 mm, 15 mm to 30 mm). Grinding of the reclaimed VCT into particulate can be performed, for example, on any type of grinder, such as a cold grinder. It is not necessary to remove tacky adhesive form the reclaimed VCT before its re-use according to embodiments of the present invention. As an option, the adhesive can be removed. Other than the attrition processing, the reclaimed VCT can be re-used as is after recovery from flooring, including any surface adhesive residue, films, coats, impurities, etc. carried by the old tile material without adversely impairing processability or finished product performance in new tile manufacture. It is considered a surprising finding that significant amounts of reclaimed VCT in a “raw” or “as-lifted-off-the-floor” condition can be incorporated into new tile manufacture. As another option, prior to compounding and thermoforming, the reclaimed VCT material can be sorted in combination with comminution processing to remove metal material content, trash or other foreign materials present with the recovered VCT material, such as using methods and systems as described herein.

After comminution (including any sorting) of the reclaimed VCT material is performed, vinyl composition tile may then be made with the reclaimed VCT material by adapting any method known in the art for producing a vinyl composition tile from a vinyl composition tile formulation. For example, in a typical manufacturing process, a vinyl composition tile formulation may be heated and formed into a vinyl composition tile by rolling or calendering to a desired thickness. The resulting rolled or calendered vinyl composition may be cut into the form of tiles by die-punching or any method known in the art. For example, rolled or calendered vinyl composition may be cut into standard 12″×12″ floor tiles, or other dimensions and/or shapes, by any known method. The thickness can be, for instance, ⅛″. The vinyl composition tile of the present invention may be combined with conventional flooring elements such as backing elements, adhesives, and/or wear layers as well as a radiation curable urethane acrylate top coating, or other top coating(s).

For purposes of the present invention, the vinyl containing formulations of this invention, which include reclaimed VCT, can be compounded and thermoformed on applicable existing equipment for the manufacture of vinyl composition tile flooring such as, for example, Banbury mixers or continuous mixers, calender trains, press molds, and/or laminating equipment.

For example, the tiles of embodiments of the present invention can be a through-chip vinyl tile or a vinyl tile made by a scratch method as those terms are understood by one skilled in the art. Generally, the tiles of the present invention can be made by taking the reclaimed VCT, vinyl homopolymer(s) and vinyl copolymer(s) and mixing them together, such as with a Banbury mixer, kneader, or the like. The mixture of the reclaimed VCT, vinyl homopolymer(s) and vinyl copolymer(s) can then be introduced to a two-roller mill, which are heated, such as at a temperature of from about 275° F. to about 350° F., though other temperatures are possible. This produces a sheeted material. At this point, accent colors, such as colorants or other accent material, can be optionally added, and then the sheeted material is cooled, such as to a temperature of 120° F. to about 150° F., though other temperatures are possible. Then, the sheeted material can be hammered or crushed into chips, which can then be subsequently blended and then reheated, such as to a temperature of 200 F. to about 250° F. This molten material is then passed through a two-roll mill and then calendared to form a sheeted material. The material is cooled, again, such as at a temperature of 100° F. to 130° F. A wax layer or other protective layer(s) can be applied and then the sheeted material is punched into tile form. As an option, the crushing or hammering of the material and re-blending and re-heating of the material is completely optional, depending upon whether one wishes to make a through-chip tile or a scratch tile.

The tiles of embodiments of the present invention can be provided in myriad styles and colors, and can be provided in shapes that can be custom cut and laid out in patterns using different colors or finishes. For example, the VCT polymer compositions of embodiments of the present invention can be used making VCT which can be used as surface coverings, such as floor coverings, wall coverings, and the like. The tiles can have any shape and/or size. The tiles can be arranged, for example, to depict a pattern, logo, and/or to guide foot traffic on a floor surface in a building. Custom-made designs are easily created using tile flooring of embodiments of the present invention.

The compositions of embodiments of this invention, which comprise reclaimed VCT material, are suitable for use in the manufacture of flooring in monolayer form, as tiles for example, and can also be used as an element, as a wear layer for example, in multilayer floorings. The flooring materials can optionally be combined with other conventional flooring elements such as backing elements, adhesive layers, and/or top wear layers.

For purposes of the present invention, the vinyl composition tiles of the present invention can meet or exceed the specifications for vinyl composition tiles set forth in ASTM-F 1066-99. Further, the vinyl composition tiles of the present invention can have or exceed the product performance and specifications of conventional vinyl composition tiles. As a non-limiting example, tiles of the present invention have any one or more (at least two, three, four, five, six, seven, eight, or all of the properties) of the following characteristics as set forth in Table III, wherein the indicated numerical range values are exemplary, and range values can deviate ±20%, particularly ±10%, more particularly ±5%, and even more particularly ±1%, from the exemplified values in the present invention:

TABLE III

| Property | Test Method | Value(s) |
|---|---|---|
| Thickness Tolerance | ASTM F 386 | ±0.127 mm |
| Out-of-Squareness | ASTM F 540 | ≦0.254 mm |
| Indentation | ASTM F 1914 (25° C., 1 min.) | 0.152-0.381 mm |
| Indentation | ASTM F 1914 (46.1° C., 30 sec.) | <0.813 mm |
| Impact | ASTM F 1265 | no break/crack beyond ZnO paste circle |
| Deflection | ASTM F 1304 | ≧25.4 mm, across & with grain w/o breaking |
| Dimensional Stability | Method 6211, Fed. Std.501(a) | ≦0.610 mm/linear ft.(30.5 cm) |
| Chemical Resistance | ASTM F 925 | slight at most, chemicals per F 1066-99, §8.3 |
| Heat Resistance | ASTM F 1514 (7 days, 70° C.) | color change ave. ΔE ≦ 8.0 |

The vinyl composition tiles of embodiments of the present invention can optionally be embossed with textures and/or designs, and this embossing can be in register with an optional printed design on the top of the tile surface. The tile can have no additional layer or coating on top or can have one or more layers above the tile and/or below the tile. For instance, the tiles of the present invention can have one or more wear layer(s) and/or top layer(s). Further, the tiles of the present invention can have a backing layer(s) and/or any intermediate-type layers. The various layers described in U.S. Pat. Nos. 6,291,078; 6,228,463; 6,218,001; 6,114,008; 5,961,903; 5,955,521; and 5,494,707 can be used, which are all incorporated in their entirety by reference herein. The tiles of the embodiments of the present invention can have wear-resistant particles and/or wear-resistant layers located on the tile and/or in the tile.

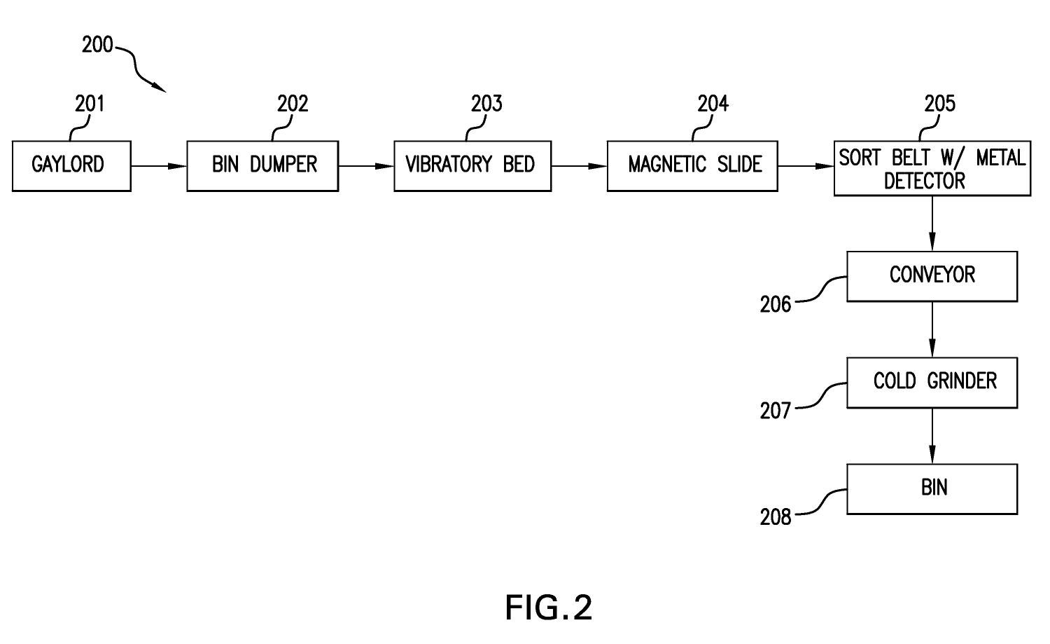

As indicated, a system is provided in other various embodiments for presorting and grinding the post-consumer reclaimed VCT material before the material is (re-)used in new VCT production, or other surface covering production or different applications. An exemplary process flow for sorting and grinding reclaimed VCT material according to various embodiments of the present invention is shown in FIG. 2. As shown in FIG. 2, a gaylord or other container containing raw reclaimed VCT material 201 is loaded into a bin dumper 202. The loaded bin dumper feeds a vibratory bed 203. The vibratory bed sifts the material forward, separating chips from fine dust for removal of the dust before grinding. The sifted chip material cascades off an end of the vibratory bed, and over a magnetic slide 204 used to capture magnetically-attractable content. After passing over the magnetic slide 204, the reclaimed VCT material falls onto a sorting conveyor belt optionally equipped with a metal detector 205. Metal detection is used to detect metal in the reclaimed VCT material that was not captured by the magnetic slide. Also, the reclaimed material can be sorted for trash and other debris as it moves down the sorting conveyor belt. After detecting for metal content, the reclaimed VCT material is transferred from the sorting conveyor belt to another conveyor 206 that feeds the reclaimed VCT material into a cold grinder 207. For example, an inclined conveyor can be used to feed a vertical feed cold grinder, or, alternatively, a horizontal conveyor can be used to feed a horizontal feed cold grinder, and so forth. The reclaimed VCT material is broken down by the cold grinder into small sized chips. The broken down chips are discharged into a collection bin 208. As indicated, the collected sorted and ground material can be used in a variety of different applications. The sorted and ground material can be used, for example, in vinyl flooring production (e.g., new VCT, solid vinyl tile (SVT), LVT, and/or sheet vinyl), carpet production (in one or more layers, like a backing layer, intermediate layer, polymer layer and/or pre-coat layer), or other uses. The sorted and ground chips obtained from this sorting and grinding operation can have a size, for example, from about 0.01 to about 2 inches, or about 0.25 to about 1.75 inches, or about 0.5 to about 1.5 inches, or about 0.75 to about 1.25 inches, or about 0.01 to about 0.04 inch. A sample of cold ground chips can have different sizes distributed within these ranges or have approximately the same size value. Other sizes of cold ground chip also may be provided and used for further processing in the production of tiles.

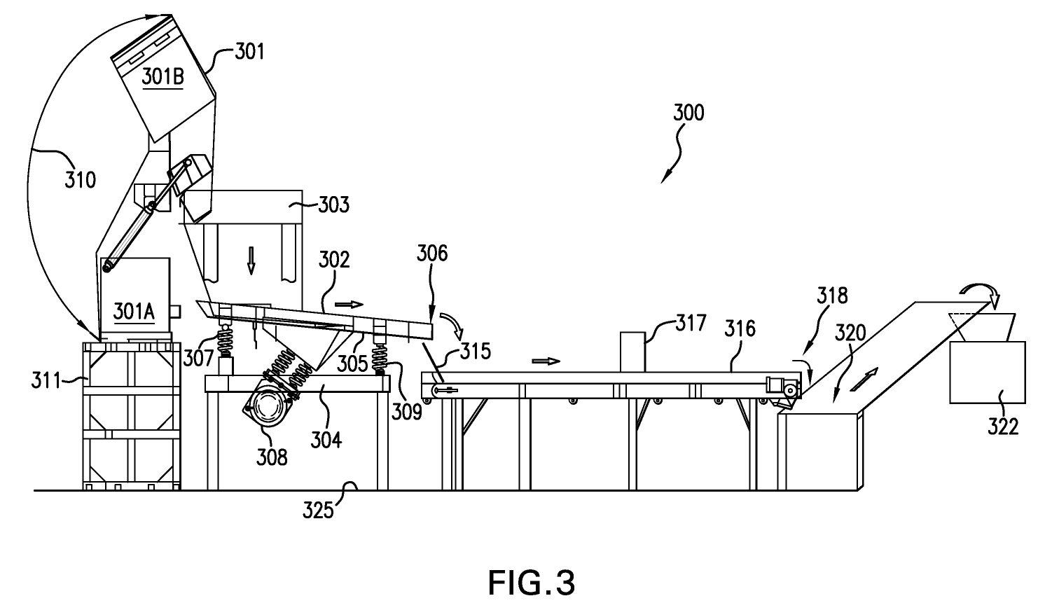

FIG. 3 shows an exemplary system and equipment layout 300 useful for sorting and grinding reclaimed VCT material according to various methods of the present invention. As shown in FIG. 3, reclaimed VCT material passes through the system 300 in the directions indicated by the flow directional arrows. The reclaimed material preferably is introduced to the system 300 in a dry or substantially dry condition, although not limited thereto to the extent the material remains flowable within the system. A hydraulic bin dumper 301, which has been loaded with a single gaylord of reclaimed VCT material, is reversibly translatable from an original position 301A on top of a elevated stand 311 through arcing distance 310 to a dumping position 301B. The bin dumper 301 transfers the reclaimed VCT material into a stationary hopper 303 that is mounted above a vibratory bed feeder 302. An approximately 50-70 degree dump angle or other suitable dumping angle may be used. The bin dumper can be include an adjustable hold down bar (not shown) to assist in containing a single gaylord within the dumper. An example of a dumper that can be used in this system is a hydraulic box dumper manufactured by Endura-Veyor Inc., Alpena, Mich. USA, such as the 2BD, 4BD or 6BD Model series devices. A particular dumper unit can be selected taking into account engineering considerations, such as the envisioned loading capacity or production rate. The bin dumper 301 feeds reclaimed VCT material to vibratory bed 302 via stationary hopper 303. The vibratory bed 302 sifts the material forward to allow it to spread into a substantially uniform thin layer of material while separating chips (coarse content) from fine dust for removal of the dust via a screening means 305. Fine dust can be undesirable during the sorting and grinding operations. Although not limited thereto, in various embodiments the screening means 305 can be designed and used to sift out fine dust having a particle size of smaller than 0.05 inch (Mesh Size No. 12 or greater). The construction of the screening means 305 is not particularly limited to the extent it can durably and efficiently separate fine dust from the chips in the reclaimed material. The screening means may, for example, be a finger deck, a metal wire mesh, a woven wire cloth screen, or other suitable screening means or other suitable particle screening means that can be applied to flowing particulate material. The vibratory bed 302 can be mounted on isolation springs with shims 307 and 309, and a fixed rate drive assembly with reactor springs 308, all supported by support frame 304, which rests on floor surface 325. The vibratory bed preferably is arranged at a small acute angle that slopes downwardly away from the hopper, such as about 1 to about 30 degrees, or about 2 to about 20 degrees, or about 3 to about 17 degrees, relative to a horizontal floor surface 325 on which the system 300 rests. The drive assembly 308 is operable for delivering increased vertical drive to assist in breaking up the material pile on the bed 302. The drive assembly 308 imparts vibrations to the vibratory bed 302 to assist or induce material break up and/or promote screening of the fine dust. An example of a vibratory bed that can be used in this system is Model FRC, manufactured by General Kinematics, Crystal Lake, Ill. USA. Although not illustrated, a horizontal (vibratory) screening device also may be used. In addition, although a linear motion screening device is exemplified herein, other screening devices, such as a circular motion screening device, also may be used in place of, or in addition to, vibratory bed 302. Further, and although not shown in FIG. 3, the contents of vibratory bed 302 can be enclosed to assist in managing dust, such as by providing an upper lid or shell structure that substantially covers the length of the bed in an air-tight manner except for the inlet and discharge outlets.

Still referring to FIG. 3, after being advanced down the length of the vibratory bed 302, the thin layer of material (overflow) cascades off discharge end 306 of the vibratory bed 302, and flows over a magnetic slide 315 arranged in a downward sloping angle relative to the material flow and floor surface 325. The magnetic slide 315 captures magnetically-attractable material contained in the reclaimed material as it passes over the magnet. An example of a magnet that can be used in this system is a rare earth magnet, such as Model PMN3536TXXU manufactured by Bunting Magnetics Co., Newton, Kans. USA. Other options for the magnetic separator include a magnetic roll separator or a magnetic slide conveyor of conventional designs. After passing over the magnetic slide 315, the reclaimed material descends onto a horizontal sorting conveyor belt 316 beneath the magnet 315. The conveyor belt 316 advances the reclaimed material past a metal detector 317 before reaching the end 318 of the conveyor belt 316. The metal detector 317 can be arranged to straddle the conveyor belt 316 at some point along the conveyor belt, such that the material passes unimpeded beneath a sensing portion of the detector 317 that arches over the conveyor belt 316. The metal detector is used to detect metal in the reclaimed VCT material that was not captured by the magnetic slide 315. The metal detector 316 detects any ferrous or non ferrous material on the belt. The metal detector 316 also can be designed to communicate with a process control means (not shown) to stop the sorting line 300 if metal is detected. When the sorting line is stopped in this manner, this allows an operator to sort through a small designated area of material to find the metal. If the metal is not found, the material on the belt can be swept off the side of the conveyor into a bin so that line may continue with other sorting. An example of the sorting conveyor 316 which can be used in this system is, for example, a Model 600 slider conveyor, manufactured by Endura-Veyor Inc., Alpina Mich. USA. An example of the metal detector 317, which can be used, for example, is PROSCAN 1200C, manufactured by Advanced Detection Systems, Milwaukee, Wis. USA. As material reaches the discharge end 318 of the sorting conveyor 316, it transfers to an incline conveyor 320 that feeds a cold grinder 322. An example of a cold grinder which can be used in this system is, for example, a Model RG series vertical feed shredder, manufactured by Vecoplan, LLC, Archdale N.C. USA. The particular model of feed grinder/shredder can be selected in view of engineering considerations, such as the feed material and size, throughput rate, product consistency, and the like.

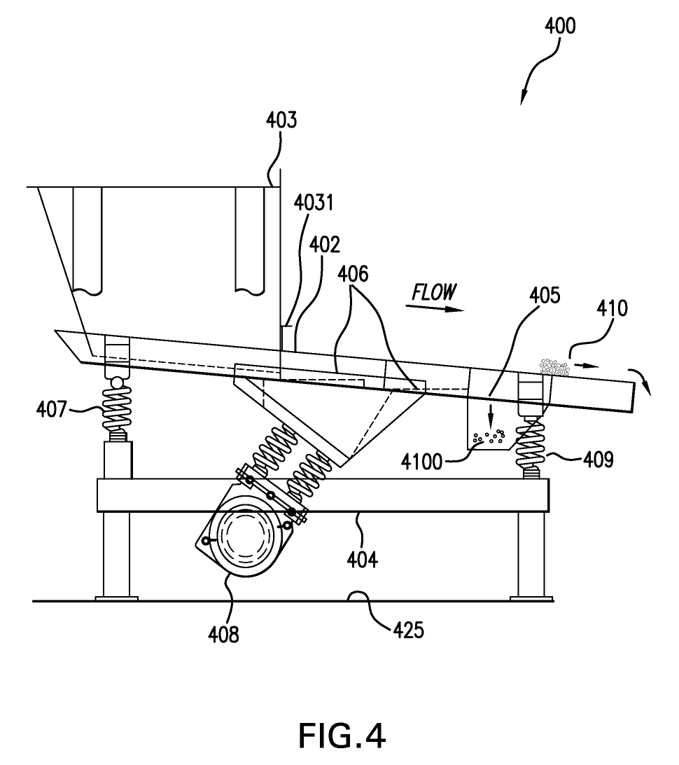

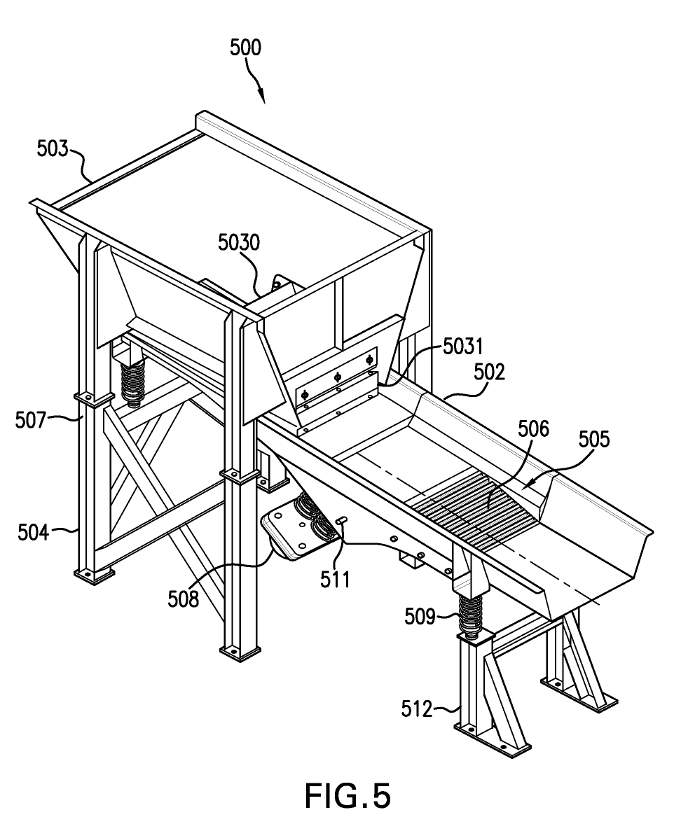

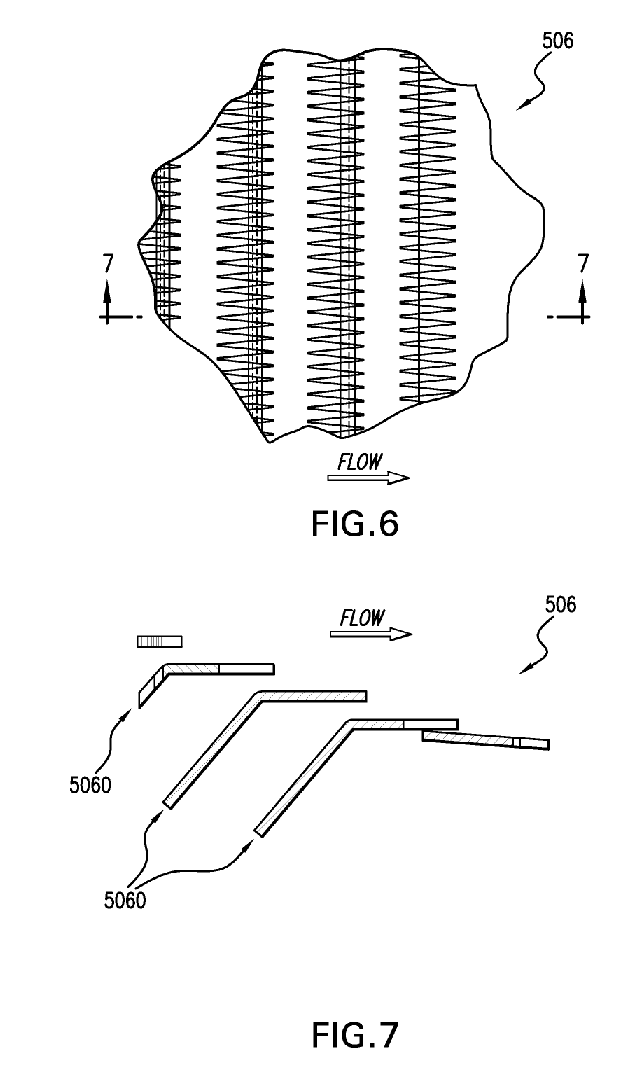

FIG. 4 shows a vibratory bed system 400 including a stationary hopper 403 for introducing reclaimed material, a lower adjustable hopper gate 4031 for releasing material from the hopper, a high stroke vibratory bed 402, which receives reclaimed material from the hopper 403 and advances the material over a screen 405 which separates and removes fine dust 4100 from chip content 410. As indicated, the reclaimed material tends to spread into a layer on the vibratory bed, and thus the particulate material 410 indicated in the figure is illustrative only. Vibratory feeder 402 has a plurality of internal steps 406 arranged in the flow direction of the bed, which function to break up the material pile. The steps can have a width that is the same or substantially the same as the upward-facing surface of the bed 402. The vibratory bed 402 is mounted on isolation springs with shims 407 and 409, and a spring-biased para-mount drive assembly 408, which are supported on support frame 404, which rests on floor surface 425. The drive assembly 408 is operable for delivering more vertical drive to assist in breaking up the material pile on the bed 402. As indicated by the flow direction arrows, larger sized chips continue down the vibratory bed 402 until discharged off the end vibratory bed, and over the magnet (not shown), and so on, similar to the scheme shown in FIG. 3. FIG. 5 shows a vibratory bed system 500 that can be used in systems of the present invention. The stationary hopper 503 in the system has a hopper cross member 5030, and an adjustable gate assembly with weighted rubber flap 5031 that is provided at lower discharge end of the hopper 503. The system 500 is mounted on isolation springs with shims 507 and 509, a spring-biased drive assembly 508, and feed end support 504 and discharge end support 512, Vibratory feeder 502 includes a finger deck section 506 at location 505 along the vibratory bed feeder length, and a motion switch 511. FIGS. 6 and 7 show the finger deck section 506 in more detail. The finger deck section 506 includes an array of fingers 5060, which function to sift out fine dust in the reclaimed material, which drops through the finger deck 506 and is collected below the vibratory bed (shown in FIG. 5), while larger sized chips continue down the vibratory feeder bed until discharged off the vibratory bed and over the magnet (not shown), and so on, similar to the scheme shown in FIG. 3. The finger deck section can be, for example, a bolt in finger deck having about 1/16 to about 5/16 inch finger openings, or other finger opening dimensions suitable to separate fine dust from chips. An example of a vibratory bed adapted to include a bolt in finger deck section, which can be used in this system is, for example, Model FRC, manufactured by General Kinematics, Crystal Lake, Ill. USA.

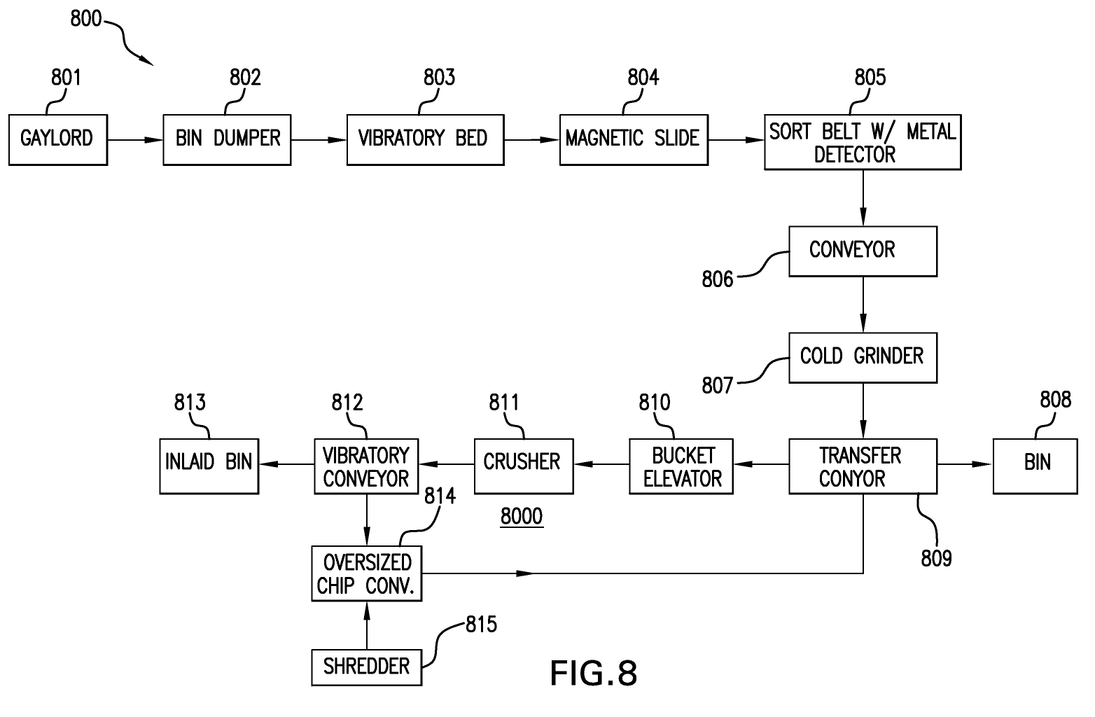

FIG. 8 shows another possible process flow for processing reclaimed VCT material according to the present invention, which permits at least some or all of the cold ground reclaimed VCT material to be diverted to a crushing operation to convert the sorted grind reclaimed material to crushed fine powder material useful for inlaid tile production or other applications. Processes 801-808 in FIG. 8, correspond to 201-208, respectively, in FIG. 2. As further shown in FIG. 8, cold ground reclaimed VCT material discharged from the cold grinder process 807 can be diverted, at least in part, via a transfer conveyor 809 to a crushing line 8000 including bucket elevator 810, crusher 811, and a vibratory conveyor 812. The vibratory conveyor sorts the crushed material to send fine powder material to inlaid bin 813 while oversize material is recycled through the crusher line 8000 via oversized chip converter 814, which also can receive chips via a separate cold grinder/shredder 815 dedicated to the crushing loop. An example of the crusher 811 that can be used is a VSI (Vertical Shaft Impact) V-Twin™ Model crusher, manufactured by Cemco, Inc., Belen, N.M. USA. Material fed into the vertical crusher hits a rotating impeller table where it is then thrown (via centrifugal force) against stationary anvils, and the impact of which shatters the material into fine powder. The particular model of vertical crusher can be selected in view of engineering considerations, such as the feed material and size, throughput rate, product consistency, and the like. The vibratory conveyor 812 used can be, for example, a vibratory conveyor, such as manufactured by Kinergy Corp., Louisville, Ky. USA, or a vibratory bed such as described above.

The present invention will be further clarified by the following examples, which are intended to be exemplary of the present invention.

### EXAMPLES

### Example 1

A VCT post consumer recycle experimental trial was performed as follows.

Approximately 20,000 sq. ft., which had a total weight of approximately 25,000 to 30,000 lbs., of VCT flooring material was demolished and reclaimed. The reclaimed tile was commercially available VCT tile that had MYLAR flakes. Three colors of non-directional tile, base color plus polyester color chips, were reclaimed and made available for these studies in the following proportions: white—approx. 50 wt %, black—approx. 25 wt %, and purple—approx. 25 wt %. Some adhesive was still adhered on the pieces of the reclaimed tile. The adhesive was cut black/asphalt emulsion adhesive. The reclaimed material was analytically tested for asbestos and tested clear for both the tile and the adhesive.

The reclaimed material was ground and pulverized for use in new VCT compounding and preparation. It was sized to ⅛ inch by grinding the pieces of reclaimed tile using a pulverizing grinder.

An initial trial in a VCT plant was done on a standard VCT pattern as an initial screening test. Four (4) batches were run out of one Banbury mixer, with the post consumer or reclaimed VCT material used at a level of 40 wt % of the overall batch. For each batch, 400 lbs. of the reclaimed VCT material was used in each batch together with an additional 600 lbs. of fresh formulation having ingredients in the proportions indicated in Table 1 below.

TABLE 1
Fresh VCT FORMULATION

| Ingredient | Wt. % |
|---|---|
| Plasticizer Blend (90 wt % BBP, 10 wt % DINP) | 3.94 |
| Georgia Gulf 1050 (vinyl chloride) homopolymer | 1.14 |
| Oxy 185 (vinyl chloride) HOMO-POLY | 4.56 |
| Colorite 4915 (vinyl chloride-vinyl acetate) CO-POLY | 2.86 |
| Petco CR-80A (vinyl chloride-vinyl acetate) copolymer | 2.86 |
| Chemson PTP-113 Stabilizer | 0.45 |
| Limestone DF-5025 | 84.19 |

In this example, the rework and fresh ingredients were mixed together in a Banbury mixer and introduced into a heated two-roller mill, wherein the temperature was from about 275° F. to about 350° F. The sheeted material was then formed and accent colors added to the sheeted material. The accent colors were polymer materials having the same homopolymer/copolymer weight ratio and included colorants or other accent materials for decorative purposes. This accent-sheeted material was then cooled to a temperature of approximately 120° F. to about 150° F. The material then was hammered or crushed into chips. These chips were then blended together and then re-heated at a temperature of approximately 200° F. to 250° F. This heated material was then subjected to a two-roller mill to form a sheeted material, which was then calendared to standard size specifications and then was cooled to a temperature of approximately 100° F. to 130° F. A wax layer was applied to the top of the sheeted material, and then the material was punched into tiles of desired dimensions, such as 12-inch×12-inch, with an overall gauge of 0.125 inch nominal.

The trial run produced batches of finished tile product that were within normal specifications, and there were no adverse issues with respect to processing or tack reported in the manufacturing process.

### Second Larger Trial Using Post Consumer VCT:

A second larger experimental trial was conducted in the VCT plant on a VCT pattern for an extended amount of time. The post consumer rework (reclaimed VCT tile) was blended in equal weight (50/50) proportion with manufacturing VCT scrap material previously obtained from the standard VCT pattern production line. A total of 400 lbs. of the 50/50 blended rework was used in each batch together with 600 lbs. fresh tile formulation. The overall rework rate thus was 40 wt % of which 200 lbs was the post consumer tile material, providing a reclaimed VCT rework proportion of 20 wt %. The VCT pattern had a similar formulation as described above for the standard VCT pattern, but also was surface-patterned which did not impact the formulation. Each batch was processed and formed into tile product using similar processing operations and steps as described above.

The trial run produced batches of finished tile product that were within normal specifications, and there were no adverse issues reported in the manufacturing process.

### Simulated Post Consumer Test:

Samples of simulated post consumer vinyl composition tile-containing flooring were prepared and analyzed in the following manner. A dozen tiles (12 inch×12 inch) were prepared using similar processing as described above in this example using the standard VCT pattern formulation. Acrylic latex adhesive was spread on one side of each tile. As an accelerated aging treatment, these tiles were placed in an oven at 200° F. for 2 hrs. The oven-baked tiles were then ground up by hand and mortar and pestle to an average size of about ½″ square. Then, the ground up VCT material was used together with fresh standard VCT with no adhesive or aging in varying proportions to provide a series of separate samples. In this regard, the following samples were prepared (amount of regrind is the amount of the previously made VCT tile with adhesive used), and the rest was masterbatch:

TABLE 2

| Sample | Wt % regrind |
|---|---|
| 1 (control) | 0 (None) |
| 2 | 10 |
| 3 | 20 |
| 4 | 30 |
| 5 | 40 |
| 6 | 50 |
| 7 | 100 |

Each sample was processed and formed into tiles in a similar manner as described above.

Samples 1 through 7 milled up very well; the more wt % regrind used, the longer it took to heat up and fuse together, which was expected and would not cause a problem in practice on a commercial scale chip line. All the sheets looked very good upon visual inspection. There was not too much tack on any one of them.

### Example 2

A VCT post consumer sorting and grinding experimental trial was performed as follows.

VCT flooring material that had been demolished and reclaimed was used. The reclaimed tile was commercially available VCT tile (e.g. standard material from Wal-Mart stores).

Process Description: There was a separate sorting and grinding trial to test all the equipment. Two different containers of the VCT reclaimed flooring were used, one per location. The material used in the grinding trial had been manually sorted to prevent equipment damage. The material was fed directly into the grinder. The layout of equipment used for the sorting trial was generally similar to that shown in FIGS. 5-7. Post consumer VCT flooring was brought to the sorting line in gaylords. A single gaylord of material was fed into the stationary hopper that was mounted above the vibratory bed feeder. The vibratory bed sifted the material forward allowing it to spread out into a thin layer which cascaded off the end of the vibratory bed, and into another Gaylord for collection. The vibratory bed also included a finger deck section which separated and removed fine dust content from the chip content, which continued down the vibratory bed.

Equipment Specifications:

Bin Dumper:
Manufacturer: Endura-Veyor Inc., Alpena, Mich. USA;
Model: 2BD-48-5248-460-PU/PD-STAND;
60° Dump Angle;
Adjustable hold down bar to contain gaylord within dumper.

Vibratory Bed:
Manufacturer: General Kinematics, Crystal Lake, Ill. USA;
Model: FRC;
Size: 30/36 Wide×9″ Deep×14′-0″ long;
Rate of Feed: 5 TPH @ 85 lbs. per cubic feet;
Stationary hopper mounted above bed capable of holding slightly over one gaylord of material;
Removable finger deck section designed to allow fine dust and contaminates to sift out as material water falls from one level of fingers to another.

Rare Earth Magnet:
Manufacturer: Bunting Magnetics Co., Newton, Kans. USA;
Model: PMN3536TXXU;
Size: 7.5″ length×36″ OAW 34″ MAG width×1.31″ thick with tapered step, approximate reach out measured 3.5″.

Sorting Conveyor:
Manufacturer: Endura-Veyor Inc., Alpena, Mich. USA;
Model: Model 600 Slider Bed Conveyor 20′0″ long×36″ EW;
Metal detector section fabricated from plastic.

Metal Detector:
Manufacturer: Advanced Detection Systems, Milwaukee, Wis. USA;
Model: PROSCAN 1200C;
Metal detector expected sensitivity:
0.098″ diameter→ferrous
0.118″ diameter→non-ferrous
0.138″ diameter→stainless steel.

Cold Grinder:
Manufacturer: Vecoplan, LLC, Belen, N.M. USA;
Model: RG52/60-K, 37-cutters;
One inch screen size.

Testing Results:

Vibratory bed testing was performed using the above system, equipment and settings, which verified that a pile of reclaimed material could be sifted into a thin layer approximately one inch thick on the vibratory bed and still maintain an estimated throughput rate of reclaimed material of 5 tons per hour.

### Example 3

A VCT post consumer crushing experimental trial was performed as follows.

VCT flooring material that had been demolished and reclaimed was used. The reclaimed tile was commercially available VCT tile. The reclaimed VCT material was sized to one inch by cold grinding the material similar to Example 2. The ground reclaimed material was fed to a VSI (Vertical Shaft Impact) V-Twin™ Model 35w (6 inch feed throat) crusher, manufactured by Cemco, Inc., Belen, N.M. USA. Portions of the ground material were crushed in different runs using different RPM's and throughputs, as indicated in Table IV. Sieve analysis was performed on the crushed product of each run, as well as the uncrushed (ground) feed material, and the results are shown in Table IV (% is by weight). The sieve results show that the VCT reclaimed material can be crushed to form fine powder having sizes. These powder sizes can be suitable for inlaid tile production.

TABLE IV

| | | Run 1, | Run 2, | Run 3, | Run 4, |
|---|---|---|---|---|---|
| | Uncrushed | 2100 RPM | 1800 RPM | 1400 RPM | 1250 RPM |
| Mesh Size | Feed | 298 FPS | 255 FPS | 198 FPS | 177 FPS |
| Mesh Sieve | % Passing | % Passing | % Passing | % Passing | % Passing |
| Size, No. | | | | | |
| (nom. | | | | | |
| opening, | | | | | |
| inch) | | | | | |
| (2.5 in.) | 100.0 | — | — | 100.0 | — |
| (2.0 in.) | 98.5 | — | 100.0 | 99.3 | 100.0 |
| (1.5 in.) | 91.8 | 100.0 | 98.4 | 92.3 | 90.3 |
| (1.0 in.) | 65.7 | 99.1 | 98.4 | 92.3 | 90.3 |
| (0.5 in.) | 41.3 | 97.2 | 89.5 | 56.0 | 51.1 |
| (0.375 in.) | 9.7 | 86.6 | 85.7 | 27.5 | 25.6 |
| 4 | 0.7 | 72.5 | 70.7 | 18.7 | 18.3 |
| (0.187 in.) | | | | | |
| 8 | 0.6 | 47.5 | 46.2 | 12.8 | 13.1 |
| (0.0937 in.) | | | | | |
| 12 | 0.4 | 38.8 | 33.4 | 7.3 | 6.4 |
| (0.0661 in.) | | | | | |
| 16 | 0.3 | 28.1 | 23.6 | 3.7 | 1.4 |
| (0.0469 in.) | | | | | |
| 30 | 0.3 | 18.1 | 14.0 | 0.4 | 0.3 |
| (0.0234 in.) | | | | | |
| 50 | 0.2 | 11.6 | 8.0 | 0.0 | 0.0 |
| (0.0117 in.) | | | | | |
| 100 | 0.1 | 5.6 | 3.8 | — | — |
| (0.0059 in.) | | | | | |

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present teachings will be apparent to those skilled in the art from consideration of the specification and practice of the present teachings disclosed herein. It is intended that the specification and examples be considered as exemplary only, with the true scope and spirit of the present invention being indicated by the following claims and equivalents thereof.

What is claimed is:

1. A flooring composition material comprising a mixture comprising virgin vinyl polymer and more than 5% by weight reclaimed vinyl composition tile material containing filler and, optionally, virgin filler, wherein said mixture has a predominant amount of total filler, and wherein said mixture is a thermoformed solidified material in individual tile form.

2. The flooring composition material of claim 1, wherein said predominant amount of filler is limestone filler.

3. The flooring composition material of claim 1, said reclaimed vinyl composition tile material comprising 20% to 85% by weight of said mixture.

4. The flooring composition material of claim 1, said reclaimed vinyl composition tile material comprising 40-60% by weight of said mixture.

5. The flooring composition material of claim 1, wherein the reclaimed vinyl composition tile material comprises at least two different sources of vinyl composition tile material having different tile styles or patterns from one another.

6. The flooring composition material of claim 1, wherein the reclaimed vinyl composition tile material comprises an adhesive on at least one surface thereof.

7. The flooring composition material of claim 1, wherein the reclaimed vinyl composition tile material comprises a thermoplastic adhesive on at least one surface thereof.

8. The flooring composition material of claim 1, wherein said material comprises a generally planar tile having a thickness of from about ⅛ inch to ½ inch.

9. The flooring composition material of claim 1, wherein said mixture further comprises at least one plasticizer, at least one stabilizer, or at least one virgin filler, or any combination thereof.

10. The flooring composition material of claim 1, further comprising at least one plasticizer and at least one stabilizer.

11. The flooring composition material of claim 1, wherein the material is a tile having a square shape having about 8 to about 20 inch side dimensions or a rectangular shape having respective side dimensions of about 14 to 18 inches by about 22 to 24 inches.

12. A vinyl composition tile comprising a thermoformed solidified material comprising a composition comprising a mixture comprising virgin vinyl polymer, more than 5% by weight reclaimed vinyl composition tile material containing filler and, optionally, virgin filler, and wherein said mixture has a predominant amount of total filler, and wherein said material is in individual tile form.

13. The vinyl composition tile of claim 12, wherein the material meets or exceeds the specifications for vinyl composition tiles set forth in ASTM F 1066-99.

14. The vinyl composition tile of claim 12, wherein the material has at least one characteristic selected from the following group: thickness tolerance per ASTM F 386 of ±0.127 mm, out-of-squareness per ASTM F 540 of ≦0.254 mm, indentation per ASTM F 1914 (25° C., 1 min.) of 0.152-0.381 mm, indentation ASTM F 1914 of (46.1° C., 30 sec.) of <0.813 mm, impact per ASTM F 1265 with no break or crack beyond ZnO paste circle, deflection per ASTM F 1304 of ≧25.4 mm across and with grain without breaking, dimensional stability per Method 6211 and Fed. Std.501(a) of ≦0.610 mm/linear ft. (30.5 cm), chemical resistance per ASTM F 925 of slight change when exposed to chemicals per F 1066-99 Section 8.3, and heat resistance per ASTM F 1514 (7 days, 70° C.) with tile color change having an average ΔE ≦8.0, singly or in any combination thereof.

15. The vinyl composition tile of claim 12, wherein said reclaimed vinyl composition tile material comprising 20% to 85% by weight of said mixture.

16. The vinyl composition tile (VCT) of claim 12, said reclaimed vinyl composition tile material comprising 40-60% by weight of said mixture.

17. A method of manufacturing a flooring composition material of claim 1, comprising:
providing a vinyl composition tile material as reclaimed vinyl composition tile material containing filler;
comminuting said reclaimed vinyl composition tile material containing filler into pieces;
heating and softening said pieces of reclaimed vinyl composition tile material,
heating and softening virgin vinyl polymer material;
combining said heated and softened pieces of reclaimed vinyl composition tile material and said virgin vinyl material before, during and/or after said heating and softening of said reclaimed vinyl composition tile material and said virgin vinyl material, and optionally further combining extraneous filler and/or recycled production scrap, providing a thermoformable mixture thereof containing at least 5% by weight reclaimed vinyl composition tile material and said mixture having a predominant amount of total filler;
thermoforming said thermoformable material into a sheet form and solidifying the sheet form, providing a solid sheet;
cutting said sheet into individual tiles.

18. The method of claim 17, further comprising compounding the heated and softened mixture of reclaimed vinyl composition tile material and virgin polymer material with at least one plasticizer, at least one stabilizer, or at least one filler, or any combination thereof.

19. The method of claim 17, wherein said thermoforming comprises calendering, molding, or extrusion, and said cutting comprises die-punching.

20. The method of claim 17, wherein said comminuting comprises grinding said recovered vinyl composition tile material to an average particle size of about 5 mm to about 50 mm.

21. The method of claim 17, comprising heating and softening said reclaimed vinyl composition tile material and said virgin vinyl polymer material with mixing thereof.

22. The method of claim 17, wherein said reclaimed vinyl composition tile material comprises at least 20% by weight of said mixture.

23. The method of claim 17, wherein said reclaimed vinyl composition tile material comprises 40-60% by weight of said mixture.

24. The method of claim 17, wherein said providing comprises separating vinyl composition tile material adhered to a floor surface from said floor surface to provide the reclaimed vinyl composition tile material as loose material.

25. The method of claim 24, wherein said loose material comprises a plurality of broken tile pieces.

26. The method of claim 17, wherein the reclaimed vinyl composition tile material comprises an adhesive on at least one surface thereof.

27. The method of claim 17, wherein the reclaimed vinyl composition tile material comprises a thermoplastic adhesive on at least one surface thereof, wherein said adhesive is present during said combining.

28. The method of claim 17, wherein the reclaimed vinyl composition tile material comprises at two different sources of vinyl composition tile material having different tile styles or patterns from one another.

29. The method of claim 17, wherein said tiles are VCT.

30. A method for covering a floor surface with vinyl composition tile flooring, comprising the steps of:
removing vinyl composition tile material containing filler, adhered to a floor surface to provide loose reclaimed vinyl composition tile material;
comminuting said reclaimed vinyl composition tile material into pieces;
heating and softening said pieces of reclaimed vinyl composition tile material,
heating and softening virgin vinyl polymer material;
combining said heated and softened pieces of reclaimed vinyl composition tile material and said virgin vinyl material before, during and/or after said heating and softening of said reclaimed vinyl composition tile material and said virgin vinyl material, and optionally further combining extraneous filler and/or recycled production scrap, providing a thermoformable mixture thereof which contains at least 5% by weight reclaimed vinyl composition tile material and wherein said thermoformable mixture has a predominant amount of total filler;
thermoforming said thermoformable material into a sheet form and solidifying the shaped sheet form, providing a solid sheet form;
cutting the solid sheet form into individual tiles;
adhering the individual tiles to an exposed floor surface, providing a floor covering.

31. The method of claim 30, wherein said comminuting comprises:
receiving reclaimed vinyl composition tile material in a vibratory bed over which the reclaimed VCT material is conveyed with removal of dust;
advancing the reclaimed VCT material over a magnetic separator for removal of magnetically-attractable content in the reclaimed VCT material;
receiving reclaimed VCT material that advances over the magnetic separator on a sorting conveyor, which conveys the reclaimed VCT material;
advancing the conveyed reclaimed VCT material past a metal detector adjacent the sorting conveyor for detection of metal not removed by the magnetic separator, providing sorted reclaimed VCT material;
receiving the sorted reclaimed VCT material in a cold grinder which grinds the sorted reclaimed VCT material into small pieces; and
collecting the ground pieces of sorted reclaimed VCT material.

32. A system for processing reclaimed vinyl composition tile (VCT) material:
a transfer device for transferring reclaimed VCT material to a sorter;
a vibratory bed for receiving the transferred reclaimed VCT material and over which the reclaimed VCT material is conveyable for removal of dust;
a magnetic separator over which the reclaimed VCT material is advanceable for removal of magnetically-attractable content in the reclaimed VCT material;
a sorting conveyor for receiving and conveying reclaimed VCT material that has advanced over the magnetic separator;
a metal detector adjacent the sorting conveyor by which the reclaimed VCT material is conveyable for detection of metal not removed by the magnetic separator, providing sorted reclaimed VCT material; and
a cold grinder for receiving sorted reclaimed VCT material and grinding the sorted reclaimed VCT material into collectible small ground pieces.

33. The system of claim 32, further comprising a crusher for receiving and crushing the ground reclaimed VCT material into fine powder having a size useful for inlaid tile.

34. The system of claim 32, further comprising a surface covering production apparatus for receiving and incorporating said ground pieces in surface covering manufacture.

35. The system of claim 32, further comprising:
a mixer for combining heated and softened sorted and ground pieces of reclaimed VCT material with virgin vinyl polymer material and/or other optional additional ingredients;
a thermoformer for forming a sheet material from the mixed rework material; and
a cutter for subdividing the sheet material into individual tiles.

36. The system of claim 34, wherein said surface covering production apparatus comprises a carpeting production apparatus.

37. A flooring composition material comprising a mixture comprising more than 80% by weight reclaimed vinyl composition tile material containing filler and contains less than 10 wt % virgin material, wherein said mixture has a predominant amount of total filler, and wherein said mixture is a thermoformed solidified material in individual tile form.

38. The flooring composition material of claim 37, wherein said mixture comprises 0 wt % virgin vinyl polymer.

39. The flooring composition material of claim 38, wherein no virgin material is present in the mixture.

40. The flooring composition material of claim 38, wherein no virgin material is present in the flooring composition material.

41. The flooring composition material of claim 40, wherein less than 3 wt % virgin material is present in the mixture.

42. A carpet comprising at least one layer comprising reclaimed vinyl composition containing filler.

43. The carpet of claim 42, wherein said at least one layer is a pre-coat layer or a backing layer.

44. The carpet of claim 42, wherein said at least one layer further comprises a non-vinyl polymer.

45. The carpet of claim 42, wherein said at least one layer is an extruded layer.
